(19) United States
(12) Patent Application Publication
(10) Pub. No.: US 2009/0102762 A1
(43) Pub. Date: Apr. 23, 2009

(54) Single-chip three color light modulator device

(76) Inventor: Scott C. Harris, Rancho Santa Fe, CA (US)

Correspondence Address: SCOTT C HARRIS, P O BOX 927649, SAN DIEGO, CA, 92192, US

(21) Appl. No.: 11/683,978

(22) Filed: Mar. 8, 2007

(51) Int. Cl. G09G 3/32

(52) U.S. Cl. 345/83

(57) ABSTRACT

a projector or television set formed by an array of devices on a single chip, where the different devices form different color portions of a single image. For example, red, green and blue portions of the single image can be formed in different pixels on the chip. Each of the red green and blue portions are combined together to form the single image. The image may be a single field of a video sequence. Any video can be formed in this same way. In this way, the single chip can be logically divided where different portions of the same chip formed the different primary colors, which are combined together to form a single video or image.

### BACKGROUND

Many video display technologies must trade-off between picture quality and cost. For example, when using a reflective style spatial light modulator technology, such as a digital micro mirror device, a trade-off between a multiple chip solution must be made against the disadvantages of time division multiplexing between the three different primary colors. Since the chip itself is typically the most expensive component of a television, most consumer devices use a single-chip DMD television. Either a rotating color wheel or some other time division device divides between times of the three primary colors: typically red, green and blue.

Other technologies, such as liquid Crystals and others have similar issues. Either one must pay for three separate chips for the three separate colors, or live with the degradation in picture quality which is obtained from such a single-chip system.

When a video display is formed from three colors that are projected at three different times, human persistence of vision usually makes these three colors appear as an overall image. Unfortunately, many users find the jumpiness of such an image to be disconcerting. In addition, since this requires that each field switches three times within each video frame, the switching may itself called cause moire affects, or other effects that can be disconcerting to some viewers.

The alternative, however, is to pay for three chips.

### SUMMARY

The present application describes logically dividing a single chip device and using logically divided portions for different color video portions, which are combined.

Aspects describe how to use new technology to form a video display, where the video display can be shaped in any desired shape, and can be used in any desired way.

### BRIEF DESCRIPTION OF THE DRAWINGS

These and other aspects will now be described in detail with reference to the accompanying drawings, wherein:

FIG. 1 shows an embodiment using a two dimensionally movable spatial light modulator;

FIGS. 2 and 3 show additional embodiments of the 2D spatial light modulator; and

FIG. 4 shows an embodiment for dividing a larger array into subsets.

### DETAILED DESCRIPTION

A first embodiment describes a way that new technology, including miniaturized projectors, can be used for projecting video. The Fraunhofer Institute (IOF) has recently produced a dual axis tiltable mirror projector which allows the output image to be projected in two axes. This “tiniest projector” is about the size of a sugar cube, and is intended to work along with red, green and blue diodes to produce a projection output.

The dual axis tilting system, however, produces interesting capabilities for multiple unit systems.

Unlike the single axis tilting system used by DMDs, a dual axis tilting system essentially allows more degrees of freedom. Accordingly, in the dual axis tilting system such as in the “smallest projector”, a multiple pixel system can divide the pixels by colors.

The present application describes video and images. The images can be still images, or can be individual “frames” of a video sequence. Some projections such as HDTV may not have conventional “frames”, but still are conceptually a series of stop images—in the sense when a video sequence is paused in time, each portion of that video sequence looks like an image. Each time period hence can be thought of as an “image”. The term image as used herein, however, is intended to refer also to a field of a moving video sequence.

Also, while the embodiments refer to specific light modulator elements, such as 2D mirrors and DMDs, it should be understood that the embodiments may cover any light modulator such as LCDs, plasma devices, and others.

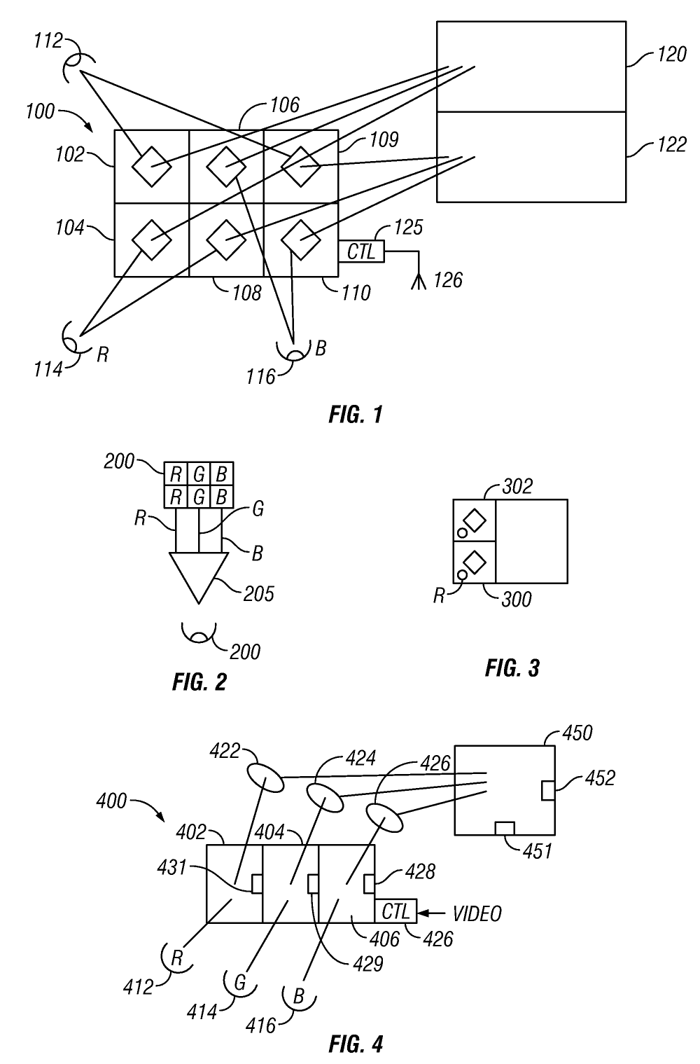

FIG. 1 shows an embodiment which is used in a television or projector. A single chip system 100 is shown which has a number of pixels such as 102, 104, 106, 108, 109, 110. Each pixel is formed of a dual axis tiltable reflective device. Pixels may receive a different primary colors, and each pixel forms a portion of the overall display.

For example, in the FIG. 1 embodiment, pixel 104 receives red illumination from the red light source 114. Pixel 102 receives green illumination from the green light source 112. Pixel 106 receives blue illumination from the blue light source 116. Each of these pixels then forms an image representing a portion or all of an entire image of a frame.

In the embodiment of FIG. 1, an image of only a portion of the frame is formed by each pixel. Since each of the pixels are dual axis tiltable, they can reflect the images to any desired area. In the FIG. 1 embodiment, the three pixels 102, 104, 106 reflect the image that forms a frame of the video display, to the same common area 120. The area 120 may be all of, or only a portion of, the overall light receiving target, e.g., a video display. In the embodiment of FIG. 1, there are six pixels. Since three pixels are used for each “area” (one for each of the primary colors) this means that a six pixel system forms two separated portions for each frame. Accordingly, as shown in FIG. 1, the pixels 102, 104,106 form a first portion of the frame shown as 120. Another portion of the frame is formed by the pixels 108, 109, 110. The light sources such as 116 each illuminate two different pixels. This may be done using any kind of known optical system, such as mirrors, half mirrors, prisms, or others.

According to another embodiment, the pixels may be arranged in some different way. For example, the pixels may be arranged as shown in FIG. 2, where each column is a specified color, with red on the left, green in the middle, and blue on the right. This may facilitate illuminating the proper color light on the pixels.

While the embodiment of FIG. 2 may be used with three separate light sources of different colors, it may also be used with a single light source shown as 200 which is split through a prism 205 into three light sources of red, green and blue. Since all the pixels for a specified color are in a line, the prism can be appropriately located so that the split light from the prism is coupled to the proper logically-divided portion of the chip 200.

As an alternative, and as shown in FIG. 3, each pixel may be formed with its own light source. In FIG. 3, the pixel 300 is formed with a red diode as part of the pixel. The pixel 302 is formed with a green diode as part of the pixel. Again, multiple pixels are combined to form the image or video.

The FIG. 1 through 3 embodiment shows only six pixels for simplicity. However, it should be understood that forming more pixels in the embodiment of FIG. 1 correspondingly forms a better picture. Accordingly, the embodiments of FIGS. 1-3 three embodiment is contemplated to include 2n pixels, where n can be any number; or more preferably 2ⁿ pixels.

A controller 125 in FIG. 1 controls the operation of the pixels. The controller may receive a signal 126 indicative of video. The video signal can be converted into red, green and blue frames/images/video parts, and used to control the individual sections and logically divided subsets.

The above has described using this system with this new 2D tiltable technology. However, it should also be understood that the same technology can be used with existing television technologies such as DMDs and liquid crystals, ferroelectric liquid crystals, or any other similar television or projector technology.

FIG. 4 illustrates an embodiment. In the FIG. 4 embodiment, a DMD array 400 that is formed of a contiguous array, on a single chip substrate is logically divided into three sections, 402, 404, 406. The DMD array may include millions of individual pixels on the single substrate DMD chip.

Each of the three sections is separately illuminated with a separate color of light. For example, section 402 is illuminated by a red light 412, section 404 is illuminated by a green light 414 and section 406 is illuminated by a blue light 416. These may be from separate illumination sources, or may be split by a prism.

The outputs at each of the DMD sections 402, 404, 406 are each are transported by optics. The optics cause the pixels from these different separated portions to be transported to the same area on the video screen.

For example, the green output from section 404 goes to optical system 422, the green output goes to optical system 424 and the red output goes to optical system 426. Each of these different optical systems has slightly different characteristics. Each section forms a subset video portion that represents a portion of the video attributable to a different primary color. The light output from each section is sent such that it ends up at the proper section on the video screen 415. By slightly adjusting the angle of the different subset video portions from the different sections, the different portions 402, 404, 406 are caused to combine on the optical screen 450.

The above describes three separate optical systems, one for each section. It should be understood, for example, that a pixel 428 within the blue will end up in the same location within frame 450 as a pixel 429 for the green and as the pixel 431 for the red.

Since it is desirable to form aspect ratios that are relatively wide, the pixels 428, 429, 431 may end up at the area 451. In that embodiment, the field formed by each section such as 402, 404, 406 is rotated 90 degrees by the respective optical system.

Alternatively, a relatively long and narrow array may be used so that no rotation is necessary. In the alternative embodiment, the pixels 428, 429, 431 may end up at the location 452.

The embodiment of FIG. 4 describes a DMD device, and the DMD device may include millions of pixels, for example a million pixels within each section 402, 404, 406.

A controller 426 in the FIG. 4 embodiment may receive the video input, in a similar way to that of the embodiment of FIG. 1.

In all the embodiments, the controller may be on the chip, or off the chip.

The above has described three primary red,green and blue colors, for additive video. However, since this system projects in a different way than the prior art, this can also be used for subtractive video, for example by using cyan, magenta, yellow as the three primary colors.

The general structure and techniques, and more specific embodiments which can be used to effect different ways of carrying out the more general goals are described herein.

Although only a few embodiments have been disclosed in detail above, other embodiments are possible and the inventor (s) intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, while the above describes three primary colors, other numbers can be used, e.g., 2 or 4 (where 4 colors might be r,g,b, white). Other layouts are possible. Other later-discovered or not specifically mentioned light modulators can be used with this system.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims.

The system may be controlled by any kind of computer, e.g. a general purpose, or some specific purpose computer such as a workstation. The computer may be an Intel (e.g., Pentium or Core 2 duo) or AMD based computer, running Windows XP or Linux, or may be a Macintosh computer. The computer may also be a handheld computer, such as a PDA, cellphone, or laptop.

The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned.

What is claimed is:

1. A method, comprising:
forming a plurality of light modulating elements on a single chip; and
using a first light modulating element that is on a first area of the chip, to project a first color of light towards a light receiving target and to form at least a first portion of a first color portion of an image on said light receiving target; and
using a second light modulating element that is on a second area of the chip different than the first area of the chip, to project a second color of light towards said light receiving target, and to form at least said first portion of a second color portion of said image on said light receiving target, where said first color portion and said second color portions are at the same location on said light receiving target.

2. A method as in claim 1, further comprising using a third light modulating element that is on a third area of the chip different than the first and second areas of the chip, to project a third color of light towards said light receiving target, and to form a third color portion of said at least first portion of the image, based on said third color of light on said light receiving target, and at the same location on said target as said first color portion and said second color portion.

3. A method as in claim 2, further comprising using a fourth light modulating element at a fourth area of the chip, to project said first color of light towards said light receiving target, and to form a different portion of the same image on the different area of the light receiving target.

4. A method as in claim 1, further comprising controlling said plurality of light modulating elements to modulate light positions in two orthogonal directions.

5. A method as in claim 1, further comprising controlling said plurality of light modulating elements to modulate light positions in a single direction.

6. A method as in claim 5, further comprising changing a transmitting direction for light from said first light modulating elements and changing a transmitting direction from said second light modulating elements.

7. A method as in claim 6, wherein said optical part also changes an orientation of the projected light by 90 degrees.

8. A system comprising:
an array of light modulating elements, all on a single chip;
a controller for said array of light modulating elements, controlling a first light modulating element of said array to project a first color of light towards a first area of a light receiving target to form at least a first color portion of an image on a first portion of said light receiving target, and to control a second light modulating element of said array, where said second light modulating element of said array is at a different location than said first light modulating element of said array, to form a second color portion, which is a different color than said first color portion, on the same first portion of said light receiving target.

9. A system as in claim 8, wherein said controller also controls a third light modulating element of said array to project a third color of light towards said first portion, to form a third color portion on said first portion.

10. A system as in claim 8, wherein said controller also controls a plurality of additional light modulating elements to modulate said first color, and controls a plurality of additional light modulating elements to modulate said second color.

11. A system as in claim 9, wherein said light modulating elements are each capable of changing a position of display of light in two orthogonal dimensions.

12. A system as in claim 9, wherein said light modulating elements are each capable of changing the position of display of light in a single dimension.

13. A system as in claim 12, further comprising an optical system, having a first portion that receives and transports said first color of light in a first direction, and a second portion that receives and transports said second color of light in a second direction, different than said first direction.

14. A system as in claim 13, wherein said optical system also rotates by a specified angle.

15. A system as in claim 8, further comprising a light source with a prism, that divides an output of the light source into primary colors.

16. A system comprising:
an contiguous array of digital micro mirror devices on a single chip;
a controller for said array of micro mirror devices that controls at least a first subset of said devices to project a first light, controls a second subset of said devices to project a second color of light, and controls a third subset of said devices to modulate a third color of light, where said control of first, second and third all occurs substantially simultaneously, so that three different colors of light frames are produced substantially simultaneously; and
an optical system, directing said three different colors of light frames to a common video target.

17. A system as in claim 16, wherein said optical system also changes an orientation of said light frames by 90°.

18. A system as in claim 16, further comprising a light source, and a device that divides the light source into multiple primary colors and provides each primary color to one of said subsets.

19. A system as in claim 16, wherein said three different colors additively combine.

20. A method comprising:
forming an array of light modulating elements on a single chip; and
logically dividing said array into portions which handle different primary colors of the same video sequence; and
controlling said array to simultaneously form said different primary colors of the video sequence, all at the same time and all in the same chip.
